(19) United States
(12) Patent Application Publication
(10) Pub. No.: US 2020/0304549 A1
(43) Pub. Date: Sep. 24, 2020

(54) Immersive Media Metrics For Field Of View

(71) Applicant: Huawei Tchnologies Co. Ltd., Shenzhen (CN)

(72) Inventor: Ye-Kui Wang, San Diego, CA (US)

(21) Appl. No.: 16/894,448

(22) Filed: Jun. 5, 2020

Related U.S. Application Data
(63) Continuation of application No. PCT/US2019/018513, filed on Feb. 19, 2019.
(60) Provisional application No. 62/646,425, filed on Mar. 22, 2018.

(51) Int. Cl. H04L 29/06; G06T 11/00; H04N 21/647; H04N 21/81

(52) U.S. Cl. CPC H04L 65/4069; G06T 11/00; G06T 2200/16; H04N 21/816; H04N 21/64784

(57) ABSTRACT

A mechanism implemented in a Dynamic Adaptive Streaming over Hypertext Transfer Protocol (HTTP) (DASH) client-side network element (NE), is disclosed. The mechanism includes receiving a DASH Media Presentation Description (MPD) describing media content including a virtual reality (VR) video sequence. The media content is obtained based on the MPD. The media content is forwarded to one or more rendering devices for rendering. A rendered FOV set metric is determined that indicates a plurality of fields of views (FOVs) of the VR video sequence as rendered by the one or more rendering devices. The rendered FOV set metric is transmitted toward a provider server.

### CROSS-REFERENCE TO RELATED APPLICATIONS

This application is a continuation of International Application No. PCT/US2019/018513 filed on Feb. 19, 2019, by Futurewei Technologies, Inc., and titled “Immersive Media Metrics for Field of View,” which claims the benefit of U.S. Provisional Patent Application No. 62/646,425, filed Mar. 22, 2018 by Ye-Kui Wang and titled “Immersive Media Metrics,” which is hereby incorporated by reference.

### TECHNICAL FIELD

The present disclosure is generally related to Virtual Reality (VR) video systems, and is specifically related to signaling VR video related data via Dynamic Adaptive Streaming over Hypertext transfer protocol (DASH).

### BACKGROUND

VR, which may also be known as omnidirectional media, immersive media, and/or three hundred sixty degree media, is an interactive recorded and/or computer-generated experience taking place within a simulated environment and employing visual, audio, and/or haptic feedback. For a visual perspective, VR provides a sphere (or sub-portion of a sphere) of imagery with a user positioned at the center of the sphere. The sphere of imagery can be rendered by a head mounted display (HMD) or other display unit. Specifically, a VR display allows a user to view a sub-portion of the sphere through a viewport. The user can dynamically change the position and/or angle of the viewport to experience the environment presented by the VR video. Each picture, also known as a frame, of the VR video includes both the area of the sphere inside the viewport and the area of the sphere outside the viewport. Hence, a VR frame includes significantly more data than a non-VR video image. Content providers are interested in providing VR video on a streaming basis. However, VR video includes significantly more data and different attributes than traditional video. As such, streaming mechanisms for traditional video are not designed to efficiently stream VR video.

### SUMMARY

In an embodiment, the disclosure includes a method implemented in a Dynamic Adaptive Streaming over Hypertext Transfer Protocol (HTTP) (DASH) client-side network element (NE). The method comprises receiving, by a receiver, a DASH Media Presentation Description (MPD) describing media content including a virtual reality (VR) video sequence. The method also comprises obtaining, via the receiver, the media content based on the MPD. The method also comprises forwarding the media content to one or more rendering devices for rendering. The method also comprises determining, via a processor, a rendered field of view (FOV) set metric indicating a plurality of FOVs of the VR video sequence as rendered by the one or more rendering devices. The method also comprises transmitting, via a transmitter, the rendered FOV set metric toward a provider server. In some cases, data can be sent from a client to the server to indicate a FOV that has been viewed by a user. Specifically, a single FOV for a single VR device can be sent to the server. However, there are instances where multiple FOVs are used by a single client, such as a computer display and a MID combination with different FOVs on each device. Further, a media gateway can be used in conjunction with multiple rendering devices that employ different FOVs at the same time. The present embodiment employs a rendered FOV set metric that indicates FOV coordinates for multiple FOV entries, with one entry per FOV. This allows for multiple related FOVs to be packaged and communicated from a client side device toward a server.

Optionally, in any of the preceding aspects, another implementation of the aspect provides, wherein the plurality of FOVs are rendered simultaneously on the one or more rendering devices.

Optionally, in any of the preceding aspects, another implementation of the aspect provides, wherein the rendered FOV set metric includes an entry object for each of the FOVs.

Optionally, in any of the preceding aspects, another implementation of the aspect provides, wherein each entry object includes a horizontal rendered FOV (renderedFOVh) value indicating a horizontal element of a corresponding FOV in units of degrees.

Optionally, in any of the preceding aspects, another implementation of the aspect provides, wherein each entry object includes a vertical rendered FOV (renderedFOVv) value indicating a vertical element of a corresponding FOV in units of degrees.

Optionally, in any of the preceding aspects, another implementation of the aspect provides, wherein the rendered FOV set metric includes a list of rendered FOV metrics for the FOVs.

Optionally, in any of the preceding aspects, another implementation of the aspect provides, wherein the DASH client-side NE is a client, a media aware intermediate NE responsible for communicating with a plurality of clients, or combinations thereof.

In an embodiment, the disclosure includes a DASH client-side NE comprising a receiver configured to receive a DASH MPD describing media content including a VR video sequence. The receiver is further configured to obtain the media content based on the MPD. The DASH client-side NE also comprises one or more ports configured to forward the media content to one or more rendering devices for rendering. The DASH client-side NE also comprises a processor coupled to the receiver and the ports. The processor is configured to determine a rendered FOV set metric indicating a plurality of FOVs of the VR video sequence as rendered by the one or more rendering devices. The processor is also configured to transmit, via the one or more ports, the rendered FOV set metric toward a provider server. In some cases, data can be sent from a client to the server to indicate a FOV that has been viewed by a user. Specifically, a single FOV for a single VR device can be sent to the server. However, there are instances where multiple FOVs are used by a single client, such as a computer display and a HMD combination with different FOVs on each device. Further, a media gateway can be used in conjunction with multiple rendering devices that employ different FOVs at the same time. The present embodiment employs a rendered FOV set metric that indicates FOV coordinates for multiple FOV entries, with one entry per FOV. This allows for multiple related FOVs to be packaged and communicated from a client side device toward a server.

Optionally, in any of the preceding aspects, another implementation of the aspect provides, wherein the plurality of FOVs are rendered simultaneously on the one or more rendering devices.

Optionally, in any of the preceding aspects, another implementation of the aspect provides, wherein the rendered FOV set metric includes an entry object for each of the FOVs.

Optionally, in any of the preceding aspects, another implementation of the aspect provides, wherein each entry object includes a renderedFOVh value indicating a horizontal element of a corresponding FOV in units of degrees.

Optionally, in any of the preceding aspects, another implementation of the aspect provides, wherein each entry object includes a renderedFOVv value indicating a vertical element of a corresponding FOV in units of degrees.

Optionally, in any of the preceding aspects, another implementation of the aspect provides, wherein the rendered FOV set metric includes a list of rendered FOV metrics for the FOVs.

Optionally, in any of the preceding aspects, another implementation of the aspect provides, wherein the DASH client-side NE is a client coupled to the one or more rendering devices via the one or more ports, and further comprising a transmitter configured to communicate with the provider server via at least one of the one or more ports.

Optionally, in any of the preceding aspects, another implementation of the aspect provides, wherein the DASH client-side NE is a media aware intermediate NE, and further comprising at least one transmitter coupled to the one or more ports configured to forward the media content to one or more rendering devices via one or more clients and transmit the rendered FOV set metric toward a provider server.

In an embodiment, the disclosure includes a non-transitory computer readable medium comprising a computer program product for use by a video coding device, the computer program product comprising computer executable instructions stored on the non-transitory computer readable medium such that when executed by a processor cause the video coding device to perform the method of any of the abovementioned aspects.

In an embodiment, the disclosure includes a DASH client-side NE comprising a receiving means for receiving a DASH MPD describing media content including a VR video sequence, and obtaining the media content based on the MPD. The DASH client-side NE also comprises a forwarding means for forwarding the media content to one or more rendering devices for rendering. The DASH client-side NE also comprises a FOV set metric means for determining a rendered FOV set metric indicating a plurality of FOVs of the VR video sequence as rendered by the one or more rendering devices. The DASH client-side NE also comprises a transmitting means for transmitting the rendered FOV set metric toward a provider server. In some cases, data can be sent from a client to the server to indicate a FOV that has been viewed by a user. Specifically, a single FOV for a single VR device can be sent to the server. However, there are instances where multiple FOVs are used by a single client, such as a computer display and a HMD combination with different FOVs on each device. Further, a media gateway can be used in conjunction with multiple rendering devices that employ different FOVs at the same time. The present embodiment employs a rendered FOV set metric that indicates FOV coordinates for multiple FOV entries, with one entry per FOV. This allows for multiple related FOVs to be packaged and communicated from a client side device toward a server.

Optionally, in any of the preceding aspects, another implementation of the aspect provides, wherein the plurality of FOVs are rendered simultaneously on the one or more rendering devices.

Optionally, in any of the preceding aspects, another implementation of the aspect provides, wherein the rendered FOV set metric includes an entry object for each of the FOVs.

Optionally, in any of the preceding aspects, another implementation of the aspect provides, wherein each entry object includes a renderedFOVh value indicating a horizontal element of a corresponding FOV in units of degrees.

Optionally, in any of the preceding aspects, another implementation of the aspect provides, wherein each entry object includes a renderedFOVv value indicating a vertical element of a corresponding FOV in units of degrees.

Optionally, in any of the preceding aspects, another implementation of the aspect provides, wherein the rendered FOV set metric includes a list of rendered FOV metrics for the FOVs.

In an embodiment, the disclosure includes a method comprising querying measurable data via one or more observation points (OPs), from functional modules to calculate metrics at a metrics computing and reporting (MCR) module, the metrics including a set of FOVs rendered by VR client devices; and employing a render FOV set metric to report the set of FOVs to an analytics server.

Optionally, in any of the preceding aspects, another implementation of the aspect provides, wherein the rendered FOV set metric includes an entry object for each of the FOVs.

Optionally, in any of the preceding aspects, another implementation of the aspect provides, wherein each entry object includes a renderedFOVh value indicating a horizontal element of a corresponding FOV in units of degrees.

Optionally, in any of the preceding aspects, another implementation of the aspect provides, wherein each entry object includes a renderedFOVv value indicating a vertical element of a corresponding FOV in units of degrees.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example system for VR based video streaming.

FIG. 2 is a flowchart of an example method of coding a VR video.

FIG. 3 is a schematic diagram of an example architecture for VR video presentation by a VR client.

FIG. 4 is a protocol diagram of an example media communication session.

FIG. 5 is a schematic diagram of an example DASH Media Presentation Description (MPD) that may be employed for streaming VR video during a media communication session.

FIG. 6 is a schematic diagram illustrating an example rendered field of view (FOV) set metric.

FIG. 7 is a schematic diagram illustrating an example video coding device.

FIG. 8 is a flowchart of an example method of communicating a rendered FOV set metric containing information related to a plurality of FOVs displayed by one or more rendering devices.

FIG. 9 is a schematic diagram of an example DASH client-side network element (NE) for communicating a rendered FOV set metric containing information related to a plurality of FOVs displayed by one or more rendering devices.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

DASH is a mechanism for streaming video data across a network. DASH provides a Media Presentation Description (MPD) file that describes a video to a client. Specifically, a MPD describes various representations of a video as well as the location of such representations. For example, the representations may include the same video content at different resolutions. The client can obtain video segments from the representations for display to the client. Specifically, the client can monitor the video buffer and/or network communication speed and dynamically change video resolution based on current conditions by switching between representations based on data in the MPD.

When applied to VR video, the MPD allows the client to obtain spherical video frames or portions thereof. The client can also determine a FOV desired by the user. The FOV includes a sub-portion of the spherical video frames that a user desires to view. The client can then render the portion of the spherical video frames corresponding to the FOV. The FOV may change dynamically at run time. For example, a user may employ an HMD that displays a FOV of the spherical video frames based on the user's head movement. This allows the user to view the VR video as if the user were present at the location of the VR camera at the time of recording. In another example, a computer coupled to a display screen (and/or a television) can display a FOV on a corresponding screen based on mouse movement, keyboard input, remote control input, etc. A FOV may even be predefined, which allows a user to experience the VR content as specified by a video producer. A group of client devices can be setup to display different FOVs on different rendering devices. For example, a computer can display a first FOV on an HMD and a second FOV on a display screen/television.

Content producers may be interested in the FOVs selected and viewed by the end users. For example, knowledge of selected FOVs may allow content producers to focus on different details in future productions. As a particular example, a high number of users selecting FOVs pointing to a particular location of a sports arena during a sporting event may indicate that a camera should be positioned at that location to provide a better view when filming subsequent sporting events. Accordingly, FOV information can be collected by service providers and used to enhance immersive media quality and related experiences. However, collecting FOV information may become problematic when multiple FOVs are employed. This is because DASH systems may not be equipped to communicate data related to multiple FOVs from a single source. In one example, a single client with multiple displays rendering multiple FOVs simultaneously may be required to communicate multiple FOVs. In another example, service providers may employ media aware devices in a network to gather FOV information from multiple clients and forward such information back to the service provider. Such systems may be unable to communicate data related to multiple FOVs that are collected at a common source.

Disclosed herein are mechanisms to communicate FOV data related to multiple FOVs from a single DASH client-side NE. As used herein, a DASH client-side NE may include a client device, a media aware intermediate NE, and/or other client/network gateway related to multiple display devices capable of rendering multiple FOVs of media content. For example, a DASH client-side NE can obtain data related to multiple FOVs and store such data in a rendered FOV set metric. The rendered FOV set metric may contain an entry for each FOV. Each entry may include a rendered FOV horizontal element and a rendered FOV vertical element describing the FOV for the entry in units of horizontal and vertical degrees, respectively. In an alternative example, a rendered FOV set metric may contain data describing a plurality of FOVs in list form. Accordingly, a client can obtain an MPD file, stream VR media content, render the VR media content based on user selected FOVs, and then report the FOVs toward a DASH content server, analytics server, and/or other provider server by employing the rendered FOV set metric.

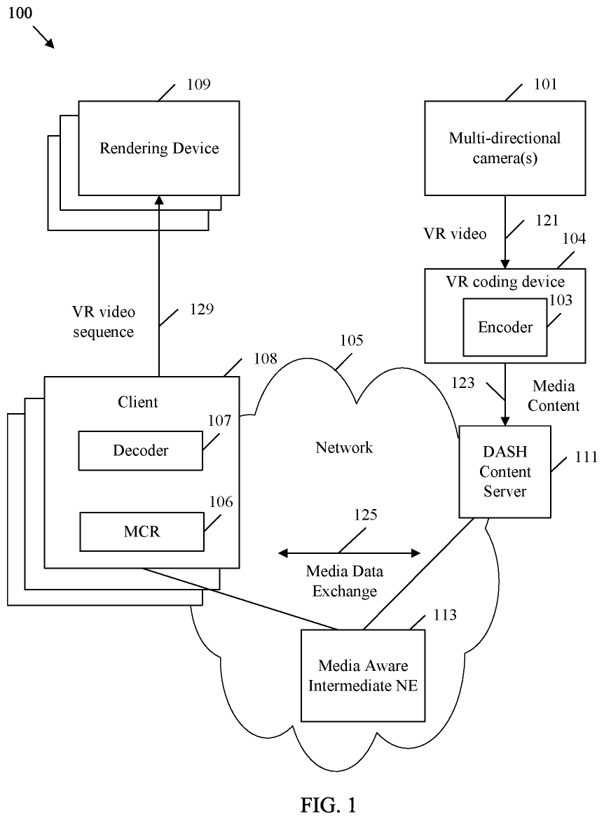

FIG. 1 is a schematic diagram of an example system 100 for VR based video streaming. System 100 includes a multi-directional camera 101, a VR coding device 104 including an encoder 103, a DASH content server 111, a client 108 with a decoder 107 and a metrics computing and reporting (MCR) module 106, and a rendering device 109. The system 100 also includes a network 105 to couple the DASH content server 111 to the client 108. In some examples, the network 105 also includes a media aware intermediate NE 113.

The multi-directional camera 101 comprises an array of camera devices. Each camera device is pointed at a different angle so that the multi-directional camera 101 can take multiple directional video streams of the surrounding environment from a plurality of angles. For example, multi-directional camera 101 can take VR video 121 of the environment as a sphere with the multi-directional camera 101 at the center of the sphere. As used herein, sphere and spherical video refers to both a geometrical sphere and sub-portions of a geometrical sphere, such as spherical caps, spherical domes, spherical segments, etc. For example, a multi-directional camera 101 may take a one hundred and eighty degree video to cover half of the environment so that a production crew can remain behind the multi-directional camera 101. A multi-directional camera 101 can also take VR video 121 in three hundred sixty degrees (or any sub-portion thereof). However, a portion of the floor under the multi-directional camera 101 may be omitted, which results in video of less than a perfect sphere. Hence, the term sphere, as used herein, is a general term used for clarity of discussion and should not be considered limiting from a geometrical stand point. It should be noted that multi-directional camera 101 as described is an example camera capable of capturing VR video 121, and that other camera devices may also be used to capture VR video (e.g., a camera, a fisheye lens).

The VR video 121 from the multi-directional camera 101 is forwarded to the VR coding device 104. The VR coding device 104 may be a computing system including specialized VR coding software. The VR coding device 104 may include an encoder 103. In some examples, the encoder 103 can also be included in a separate computer system from the VR coding device 104. The VR coding device 104 is configured to convert the multiple directional video streams in the VR video 121 into a single multiple directional video stream including the entire recorded area from all relevant angles. This conversion may be referred to as image stitching. For example, frames from each video stream that are captured at the same time can be stitched together to create a single spherical image. A spherical video stream can then be created from the spherical images. For clarity of discussion, it should be noted that the terms frame, picture, and image may be used interchangeably herein unless specifically noted.

The spherical video stream can then be forwarded to the encoder 103 for compression. An encoder 103 is a device and/or program capable of converting information from one format to another for purposes of standardization, speed, and/or compression. Standardized encoders 103 are configured to encode rectangular and/or square images. Accordingly, the encoder 103 is configured to map each spherical image from the spherical video stream into a plurality of rectangular sub-pictures. The sub-pictures can then be placed in separate sub-picture video streams. As such, each sub-picture video stream displays a stream of images over time as recorded from a sub-portion of the spherical video stream. The encoder 103 can then encode each sub-picture video stream to compress the video stream to a manageable file size. In general, the encoder 103 partitions each frame from each sub-picture video stream into pixel blocks, compresses the pixel blocks by inter-prediction and/or intra-prediction to create coding blocks including prediction blocks and residual blocks, applies transforms to the residual blocks for further compression, and applies various filters to the blocks. The compressed blocks as well as corresponding syntax are stored in bitstream(s), for example as tracks in International Standardization Organization base media file format (ISOBMFF) and/or in omnidirectional media format (OMAF).

The encoded tracks from the VR video 121, including the compressed blocks and associated syntax, form part of the media content 123. The media content 123 may include encoded video files, encoded audio files, combined audio video files, media represented in multiple languages, subtitled media, metadata, or combinations thereof. The media content 123 can be separated into adaptation sets. For example, video from a viewpoint can be included in an adaptation set, audio can be included in another adaptation set, closed captioning can be included in another adaptation set, metadata can be included into another adaptation set, etc. Adaptation sets contain media content 123 that is not interchangeable with media content 123 from other adaptation sets. The content in each adaptation set can be stored in representations, where representations in the same adaptation set are interchangeable. For example, VR video 121 from a single viewpoint can be downsampled to various resolutions and stored in corresponding representations. As used herein, a viewpoint is a location of one or more cameras when recording a VR video 121. As another example, audio (e.g., from a single viewpoint) can be downsampled to various qualities, translated into different languages, etc. and stored in corresponding representations.

The media content 123 can be forwarded to a DASH content server 111 for distribution to end users over a network 105. The DASH content server 111 may be any device configured to serve HyperText Transfer Protocol (HTTP) requests from a client 108. The DASH content server 111 may comprise a dedicated server, a server cluster, a virtual machine (VM) in a cloud computing environment, or any other suitable content management entity. The DASH content server 111 may receive media content 123 from the VR coding device 104. The DASH content server 111 may generate an MPD describing the media content 123. For example, the MPD can describe preselections, viewpoints, adaptation sets, representations, metadata tracks, segments thereof, etc. as well as locations where such items can be obtained via a HTTP request (e.g., a HTTP GET).

A client 108 with a decoder 107 may enter a media communication session 125 with the DASH content server 111 to obtain the media content 123 via a network 105. The network 105 may include the Internet, a mobile telecommunications network (e.g., a long term evolution (LTE) based data network), or other data communication data system. The client 108 may be any user operated device for viewing video content from the media content 123, such as a computer, television, tablet device, smart phone, etc. The media communication session 125 may include making a media request, such as a HTTP based request (e.g., an HTTP GET request). In response to receiving an initial media request, the DASH content server 111 can forward the MPD to the client 108. The client 108 can then employ the information in the MPD to make additional media requests for the media content 123 as part of the media communication session 125. Specifically, the client 108 can employ the data in the MPD to determine which portions of the media content 123 should be obtained, for example based on user preferences, user selections, buffer/network conditions, etc. Upon selecting the relevant portions of the media content 123, the client 108 uses the data in the MPD to address the media request to the location at the DASH content server 111 that contains the relevant data. The DASH content server 111 can then respond to the client 108 with the requested portions of the media content 123. In this way, the client 108 receives requested portions of the media content 123 without having to download the entire media content 123, which saves network resources (e.g., time, bandwidth, etc.) across the network 105.

The decoder 107 is a device at the user's location (e.g., implemented on the client 108) that is configured to reverse the coding process of the encoder 103 to decode the encoded bitstream(s) obtained in representations from the DASH content server 111. The decoder 107 also merges the resulting sub-picture video streams to reconstruct a VR video sequence 129. The VR video sequence 129 contains the portion of the media content 123 as requested by the client 108 based on user selections, preferences, and/or network conditions and as reconstructed by the decoder 107. The VR video sequence 129 can then be forwarded to the rendering device 109. The rendering device 109 is a device configured to display the VR video sequence 129 to the user. For example, the rendering device 109 may include an HMD that is attached to the user's head and covers the user's eyes. The rendering device 109 may include a screen for each eye, cameras, motion sensors, speakers, etc. and may communicate with the client 108 via wireless and/or wired connections. In other examples, the rendering device 109 can be a display screen, such as a television, a computer monitor, a tablet personal computer (PC), etc. The rendering device 109 may display a sub-portion of the VR video sequence 129 to the user. The sub-portion shown is based on the FOV and/or viewport of the rendering device 109. As used herein, a viewport is a two dimensional plane upon which a defined portion of a VR video sequence 129 is projected. A FOV is a conical projection from a user's eye onto the viewport, and hence describes the portion of the VR video sequence 129 the user can see at a specified point in time. The rendering device 109 may change the position of the FOV based on user head movement by employing the motion tracking sensors. This allows the user to see different portions of the spherical video stream depending on head movement. In some cases, the rendering device 109 may offset the FOV for each eye based on the user's interpupillary distance (IPD) to create the impression of a three dimensional space. In some cases, the FOV may be predefined to provide a particular experience to the user. In other examples, the FOV may be controlled by mouse, keyboard, remote control, or other input devices.

The client 108 also includes an MCR module 106, which is a module configured to query measurable data from various functional modules operating on the client 108 and/or rendering device 109, calculate specified metrics, and/or communicate such metrics to interested parties. The MCR module 106 may reside inside or outside of the VR client 108. The specified metrics may then be reported to an analytics server, such as DASH content server 111 or other entities interested and authorized to access such metrics. The analytics server or other entities may use the metrics data to analyze the end user experience, assess client 108 device capabilities, and evaluate the immersive system performance in order to enhance the overall immersive service experience across network 105, platform, device, applications, and/or services.

For example, the MCR module 106 can measure and report the FOV displayed on the rendering device 109. In some cases, multiple rendering devices 109 can be employed simultaneously by the client 108. For example, the client 108 can be coupled to an HMD, a computer display screen, and/or a television. As a specific example, the HMD may render a FOV of the VR video sequence 129 based on the user's head movement. Meanwhile, the display screen and/or television may render a FOV of the VR video sequence 129 based on instructions in a hint track, and hence display a predefined FOV. In another example, a first user may direct the FOV rendered by the HMD while a second user directs the FOV rendered by the display/television. Further, multiple users may employ multiple HMDs with different FOVs rendering a shared VR video sequence 129. As such, multiple cases exist where a MCR module 106 may be directed to measure and report multiple FOVs. The MCR module 106 can perform such an action by employing a rendered FOV set metric, which may include an unordered set or an ordered list of rendered FOVs used by rendering devices 109 associated with the client 108. Specifically, the MCR module 106 can encode the FOV used by each rendering device 109 for each frame or for groups of frames as an entry in the rendered FOV set metric and forward the rendered FOV set metric back to the service provider (e.g., the DASH content server 111) at the end of the VR video sequence 129, periodically during rendering, at specified break points, etc. The timing of the communication of the rendered FOV set metric may be set by the user and/or by the service provider (e.g., by agreement).

In some examples, the network 105 may include a media aware intermediate NE 113. The media aware intermediate NE 113 is a device that maintains awareness of media communication sessions 125 between one or more DASH content servers 111 and one or more clients 108. For example communications associated with the media communication sessions 125, such as setup messages, tear down messages, status messages, and/or data packets containing VR video data may be forwarded between the DASH content server(s) 111 and the client(s) 108 via the media aware intermediate NE 113. Further, metrics from the MCR module 106 may be returned via the media aware intermediate NE 113. Accordingly, the media aware intermediate NE 113 can aggregate the FOV data from multiple clients 108 for communication back to the service provider. Hence, the media aware intermediate NE 113 can receive FOV data (e.g., in rendered FOV set metric(s)) from a plurality of clients 108 (e.g., with one or more rendering devices 109 associated with each client 108) aggregate such data as entries in a rendered FOV set metric, and forward the rendered FOV set metric back to the service provider. Hence, the rendered FOV set metric provides a convenient mechanism to report an arbitrary number of rendered FOVs in a single metric.

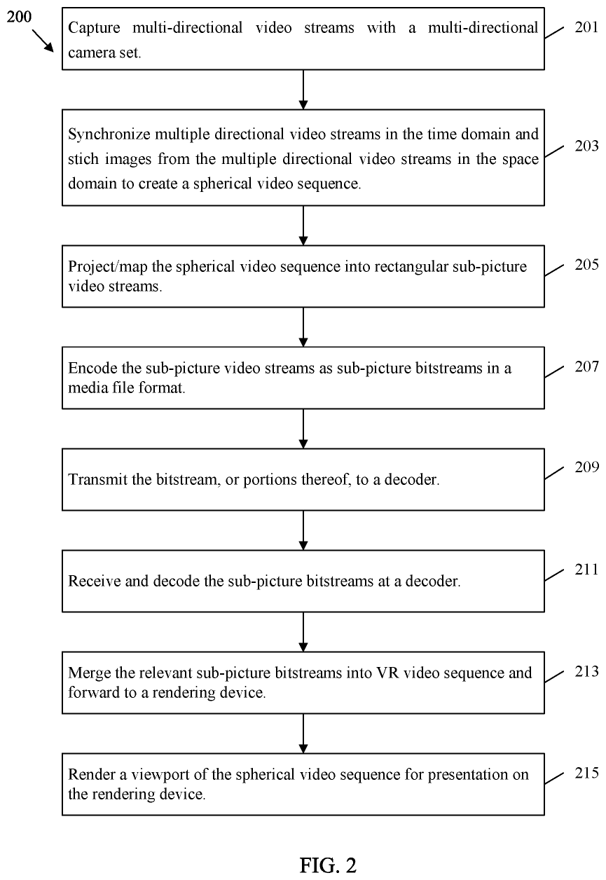

FIG. 2 is a flowchart of an example method 200 of coding a VR video, for example by employing the components of system 100. At step 201, a multi-directional camera set, such as multi-directional camera 101, is used to capture multiple directional video streams. The multiple directional video streams include views of an environment at various angles. For example, the multiple directional video streams may capture video from three hundred sixty degrees, one hundred eighty degrees, two hundred forty degrees, etc. around the camera in the horizontal plane. The multiple directional video streams may also capture video from three hundred sixty degrees, one hundred eighty degrees, two hundred forty degrees, etc. around the camera in the vertical plane. The result is to create video that includes information sufficient to cover a spherical area around the camera over some period of time.

At step 203, the multiple directional video streams are synchronized in the time domain. Specifically, each directional video stream includes a series of images taken at a corresponding angle. The multiple directional video streams are synchronized by ensuring frames from each directional video stream that were captured at the same time domain position are processed together. The frames from the directional video streams can then be stitched together in the space domain to create a spherical video stream. Hence, each frame of the spherical video stream contains data taken from the frames of all the directional video streams that occur at a common temporal position.

At step 205, the spherical video stream is mapped into rectangular sub-picture video streams. This process may also be referred to as projecting the spherical video stream into rectangular sub-picture video streams. Encoders and decoders are generally designed to encode rectangular and/or square frames. Accordingly, mapping the spherical video stream into rectangular sub-picture video streams creates video streams that can be encoded and decoded by non-VR specific encoders and decoders, respectively. It should be noted that steps 203 and 205 are specific to VR video processing, and hence may be performed by specialized VR hardware, software, or combinations thereof.

At step 207, the rectangular sub-picture video streams making up the VR video can be forwarded to an encoder, such as encoder 103. The encoder then encodes the sub-picture video streams as sub-picture bitstreams in a corresponding media file format. Specifically, each sub-picture video stream can be treated by the encoder as a video signal. The encoder can encode each frame of each sub-picture video stream via inter-prediction, intra-prediction, etc. Regarding file format, the sub-picture video streams can be stored in ISOBMFF. For example, the sub-picture video streams are captured at a specified resolution. The sub-picture video streams can then be downsampled to various lower resolutions for encoding. Each resolution can be referred to as a representation. Lower quality representations lose image clarity while reducing file size. Accordingly, lower quality representations can be transmitted to a user using fewer network resources (e.g., time, bandwidth, etc.) than higher quality representations with an attendant loss of visual quality. Each representation can be stored in a corresponding set of tracks at a DASH content server, such as DASH content server 111. Hence, tracks can be sent to a user, where the tracks include the sub-picture bitstreams at various resolutions (e.g., visual quality).

At step 209, the sub-picture bitstreams can be sent to the decoder as tracks. Specifically, an MPD describing the various representations can be forwarded to the client from the DASH content server. This can occur in response to a request from the client, such as an HTTP GET request. For example, the MPD may describe various adaptation sets containing various representations. The client can then request the relevant representations, or portions thereof, from the desired adaptation sets.

At step 211, a decoder, such as decoder 107, receives the requested representations containing the tracks of sub-picture bitstreams. The decoder can then decode the sub-picture bitstreams into sub-picture video streams for display. The decoding process involves the reverse of the encoding process (e.g., using inter-prediction and intra-prediction). Then, at step 213, the decoder can merge the sub-picture video streams into the spherical video stream for presentation to the user as a VR video sequence. The decoder can then forward the VR video sequence to a rendering device, such as rendering device 109.

At step 215, the rendering device renders a FOV of the spherical video stream for presentation to the user. As mentioned above, areas of the VR video sequence outside of the FOV at each point in time may not be rendered.

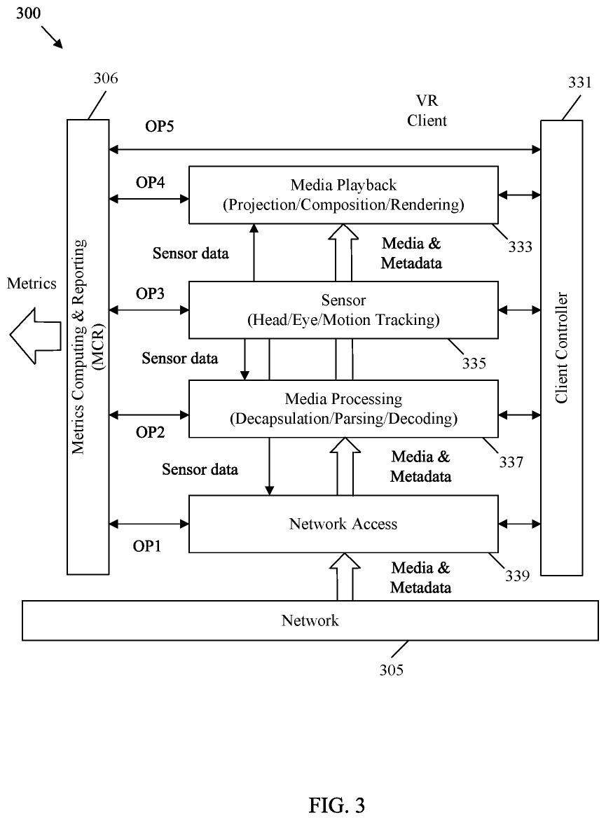

FIG. 3 is a schematic diagram of an example architecture 300 for VR video presentation by a VR client, such as a client 108 as shown in FIG. 1. Hence, architecture 300 may be employed to implement steps 211, 213, and/or 215 of method 200 or portions thereof. The architecture 300 may also be referred to as an immersive media metrics client reference model, and employs various observation points (OPs) for measuring metrics.

The architecture 300 includes a client controller 331, which includes hardware to support performance of client functions. Hence, the client controller 331 may include processor(s), random access memory, read only memory, cache memory, specialized video processors and corresponding memory, communications busses, network cards (e.g., network ports, transmitters, receivers), etc. The architecture 300 includes a network access module 339, a media processing module 337, a sensor module 335, and a media playback module 333, which are functional modules containing related functions operating on the client controller 331. As a specific example, the VR client may be configured as an OMAF player for file/segment reception or file access, file/segment decapsulation, decoding of audio, video, or image bitstreams, audio and image rendering, and viewport selection configured according to such modules.

The network access module 339 contains functions related to communications with a network 305, which may be substantially similar to network 105. Hence, the network access module 339 initiates a communication session with a DASH content server via the network 305, obtains an MPD, and employs HTTP functions (e.g., GET, POST, etc.) to obtain VR media and supporting metadata. The media includes video and audio data describing the VR video sequence, and can include encoded VR video frames and encoded audio data. The metadata includes information that indicates to the VR client how the VR video sequence should be presented. In a DASH context, the media and metadata may be received as tracks and/or track segments of selected representations from corresponding adaptation sets. The network access module 339 forwards the media and metadata to the media processing module 337.

The media processing module 337 may be employed to implement a decoder 107 of system 100. The media processing module 337 manages decapsulation which is the process of removing headers from network packets to obtain data from a packet payload, in this case the media and metadata. The media processing module 337 also manages parsing which is the process of analyzing bits in the packet payload to determine the data contained therein. The media processing module 337 also decodes the parsed data by employing partitioning to determine the position of coding blocks, applying reverse transforms to obtain residual data, employing intra-prediction and/or inter-prediction to obtain coding blocks, applying the residual data to the coding blocks to reconstruct the encoded pixels of the VR image, and merging the VR image data together to create a VR video sequence. The decoded VR video sequence is forwarded to the media playback module 333.

The client controller 331 may also include a sensor module 335. For example, an HMD may include multiple sensors to determine user activity. The sensor module 335 on the client controller 331 interprets output from such sensors. For example, the sensor module 335 may receive data indicating movement of the HMD which can be interpreted as head movement of the user. The sensor module 335 may also receive eye tracking information indicating user eye movement. The sensor module 335 may also receive other motion tracking information as well as any other VR presentation related input from the user. The sensor module 335 processes such information and outputs sensor data. Such sensor data may indicate the user's current FOV and/or changes in user FOV over time based on motion tracking (e.g., head and/or eye tracking). The sensor data may also include any other relevant feedback from the rendering device. The sensor data can be forwarded to the network access module 339, the media processing module 337, and/or the media playback module 333 as desired.

The media playback module 333 employs the sensor data, the media data, and the metadata to manage rendering of the VR sequence by the relevant rendering device, such as rendering device 109 of system 100. For example, the media playback module 333 may determine the preferred composition of the VR video sequence based on the metadata (e.g., based on frame timing/order, etc.) The media playback module 333 may also create a spherical projection of the VR video sequence. In the event that the rendering device is a screen, the media playback module 333 may determine a relevant FOV/viewport based on user input received at the client controller 331 (e.g., from a mouse, keyboard, remote, etc.) When the rendering device is an HMD, the media playback module 333 may determine the FOV/viewport based on sensor data related to head and/or eye tracking. The media playback module 333 employs the determined FOV/viewport to determine the section(s) of the spherical projection of the VR video sequence to render. The media playback module 333 can then forward the portion of the VR video sequence to be rendered to the rendering device for display to the user.

The architecture 300 also includes an MCR module 306, which may be employed to implement a MCR module 106 from system 100. The MCR module 306 queries the measurable data from the various functional modules and calculates specified metrics. The MCR module 306 may reside inside or outside of the VR client. The specified metrics may then be reported to an analytics server or other entities interested and authorized to access such metrics. The analytics server or other entities may use the metrics data to analyze the end user experience, assess client device capabilities, and evaluate the immersive system performance in order to enhance the overall immersive service experience across network, platform, device, applications, and services. The MCR module 306 can review data by employing various interfaces, referred to as observation points, and denoted as OP1, OP2, OP3, OP4, and OP5. The MCR module 306 can also determine corresponding metrics based on the measured data, which can be reported back to the service provider.

OP1 allows the MCR module 306 to access to the network access module 339, and hence allows the MCR module 306 to measure metrics related to issuance of media file/segment requests and receipt of media files or segment streams from the network 305.

OP2 allows the MCR module 306 to access the media processing module 337, which processes the file or the received segments, extracts the coded bitstreams, parses the media and metadata, and decodes the media. The collectable data of OP2 may include various parameters such as MPD information, which may include media type, media codec, adaptation set, representation, and/or preselection identifiers (IDs). OP2 may also collect OMAF metadata such as omnidirectional video projection, omnidirectional video region-wise packing, and/or omnidirection viewport. OP2 may also collect other media metadata such as frame packing, color space, and/or dynamic range.

OP3 allows the MCR module 306 to access the sensor module 335, which acquires the user's viewing orientation, position, and interaction. Such sensor data may be used by network access module 339, media processing module 337, and media playback module 333 to retrieve, process, and render VR media elements. For example, the current viewing orientation may be determined by the head tracking and possibly also eye tracking functionality. Besides being used by the renderer to render the appropriate part of decoded video and audio signals, the current viewing orientation may also be used by the network access module 339 for viewport dependent streaming and by the video and audio decoders for decoding optimization. OP3, for example, may measure various information of collectable sensor data, such as the center point of the current viewport, head motion tracking, and/or eye tracking.

OP4 allows the MCR module 306 to access the media playback module 333, which synchronizes playbacks of the VR media components to provide a fully immersive VR experience to the user. The decoded pictures can be projected onto the screen of a head-mounted display or any other display device based on the current viewing orientation or viewport based on metadata that includes information on region-wise packing, frame packing, projection, and sphere rotation. Likewise, decoded audio is rendered, e.g., through headphones, according to the current viewing orientation. The media playback module 333 may support color conversion, projection, and media composition for each VR media component. The collectable data from OP4 may, for example, include the media type, the media sample presentation timestamp, wall clock time, actual rendered viewport, actual media sample rendering time, and/or actual rendering frame rate.

OP 5 allows the MCR module 306 to access the VR client controller 331, which manages player configurations such as display resolution, frame rate, FOV, lens separation distance, etc. OP5 may be employed to measure client capability and configuration parameters. For example, the collectable data from OP5 may include display resolution, display density (e.g., in units of pixels per inch (PPI)), horizontal and vertical FOV (e.g., in units of degrees), media format and codec support, and/or operating system (OS) support.

Accordingly, the MCR module 306 can determine various metrics related to VR video sequence rendering and communicate such metric back to a service provider via the network access module 339 and the network 305. For example, the MCR module 306 can determine the FOV rendered by one or more rendering devices via OP5. The MCR module can then include such information in a rendered FOV set metric for communication back to the service provider.

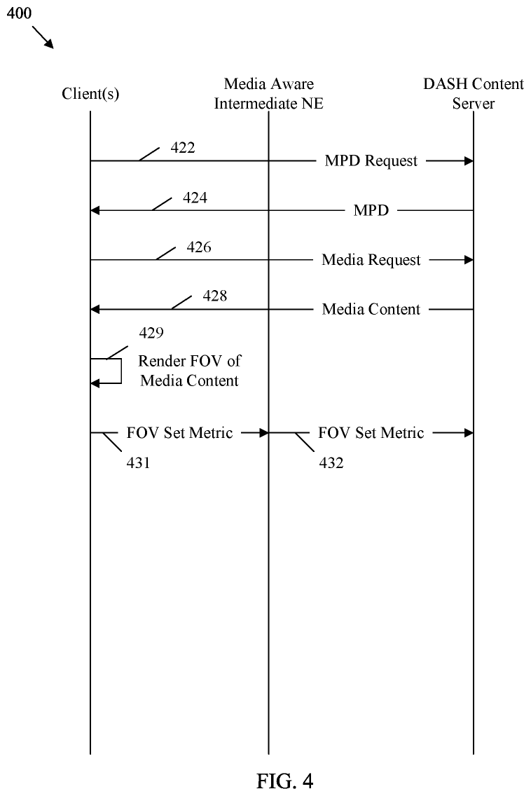

FIG. 4 is a protocol diagram of an example media communication session 400. For example, media communication session 400 can be employed to implement a media communication session 125 in system 100. Further, media communication session 400 can be employed to implement steps 209 and/or 211 of method 200. Further, media communication session 400 can be employed to communicate media and metadata to a VR client functioning according to architecture 300 and return corresponding metrics computed by a MCR module 306.

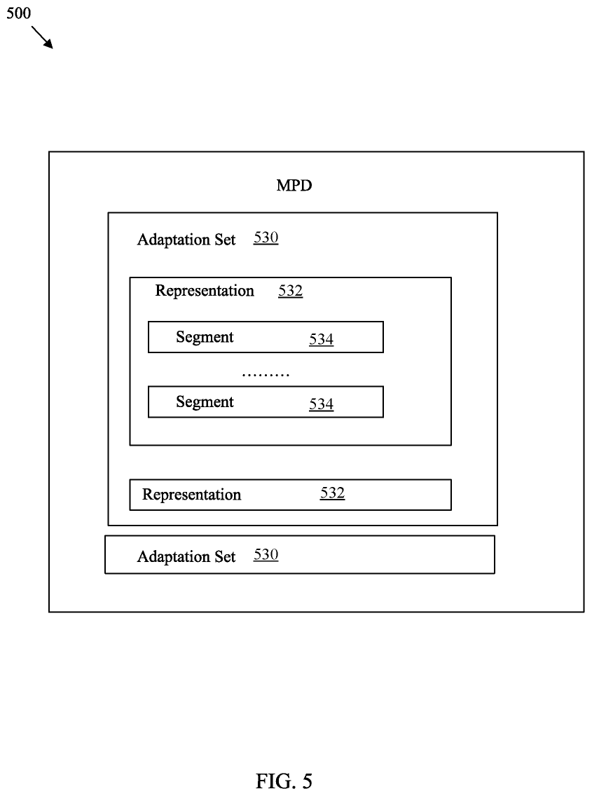

Media communication session 400 may begin at step 422 when a client, such as client 108, sends an MPD request message to a DASH content server, such as DASH content server 111. The MPD request is an HTTP based request for an MPD file describing specified media content, such as a VR video sequence. The DASH content server receives the MPD request from step 422 and responds by sending an MPD to the client at step 424. The MPD describes the video sequence and describes a mechanism for determining the location of the components of the video sequence. This allows the client to address requests for desired portions of the media content. An example MPD is described in greater detail with reference to FIG. 5 below.

Based on the MPD, the client can make media requests from the DASH content server at step 426. For example, media content can be organized into adaptation sets. Each adaptation set may contain one or more interchangeable representations. The MPD describes such adaptation sets and representations. The MPD may also describe the network address location of such representations via static address(es) and/or an algorithm to determine the address(es) of such representations. Accordingly, the client creates media requests to obtain the desired representations based on the MPD of step 424. This allows the client to dynamically determine the desired representations (e.g., based on network speed, buffer status, requested viewpoint, FOV/viewport used by the user, etc.). The client then sends the media requests to the DASH content server at step 426. The DASH content server replies to the media requests of step 426 by sending messages containing media content back to the client at step 428. For example, the DASH content server may send a three second clip of media content to the client in response to a media request. This allows the client to dynamically change representations, and hence resolutions, based on changing conditions (e.g., request higher resolution segments when network conditions are favorable and lower resolution segments when the network is congested, etc.). As such, media requests of step 426 and responsive media content messages of step 428 may be exchanged repeatedly.

The client renders the received media content at step 429. Specifically, the client may project the received media content (according to media playback module 333), determine an FOV of the media content based on user input or sensor data, and render the FOV of the media content at one or more rendering devices. As noted above, the client may employ an MCR module to measure various metrics related to the rendering process. Accordingly, the client can also generate a rendered FOV set metric at step 429. The rendered FOV set metric contains an entry for each of the one or more rendering devices. Each entry indicates the FOV of the corresponding rendering device. Accordingly, the rendered FOV set metric can be employed to report multiple FOVs when multiple rendering devices are employed by the same client. The rendered FOV set metric is then sent from the client toward the DASH content server at step 431.

In other examples, a media aware intermediate NE may operate in a network between the client and DASH content server. Specifically, the media aware intermediate NE may passively listen to media communication sessions 400 between one or more DASH content servers and a plurality of clients, each with one or more rendering devices. Accordingly, the clients may forward FOV information to the media aware intermediate NE, either in a rendered FOV set metric of step 431 or other data message. The media aware intermediate NE can then aggregate the FOV information from the plurality of clients in a rendered FOV set metric, which is substantially similar to rendered FOV set metric received at step 431 but contains FOVs corresponding to multiple clients. The rendered FOV set metric can then be sent toward the DASH content server at step 432. It should be noted that the rendered FOV set metric of steps 431 and/or 432 can be sent to any server operated by the service provider, such as a DASH content server, an analytics server, or other server. The DASH content server is used in this example to support simplicity and clarity and hence should not be considered limiting unless otherwise specified.

FIG. 5 is a schematic diagram of an example DASH MPD 500 that may be employed for streaming VR video during a media communication session. For example, MPD 500 can be used in a media communication session 125 in system 100. Hence, an MPD 500 can be used as part of steps 209 and 211 of method 200. Further, MPD 500 can be employed by a network access module 339 of architecture 300 to determine media and metadata to be requested. In addition, MPD 500 can be employed to implement an MPD in media communication session 400.

The MPD 500 can also include one or more adaptation set(s) 530. An adaptation set 530 contains one or more representations 532. Specifically, an adaptation set 530 contains representations 532 that are of a common type and that can be rendered interchangeably. For example, audio data, video data, and metadata would be positioned in different adaptation sets 530 as a type of audio data that cannot be swapped with a type of video data without effecting the media presentation. Further, video from different viewpoints are not interchangeable as such videos contain different images, and hence could be included in different adaptation sets 530.

Representations 532 may contain media data that can be rendered to create a part of a multi-media presentation. In the video context, representations 532 in the same adaptation set 530 may contain the same video at different resolutions. Hence, such representations 532 can be used interchangeably depending on the desired video quality. In the audio context, representations 532 in a common adaptation set 530 may contain audio of varying quality as well as audio tracks in different languages. A representation 532 in an adaptation set 530 can also contain metadata such as a timed metadata track (e.g., a hint track). Hence, a representation 532 containing the time metadata can be used in conjunction with a corresponding video representation 532, an audio representation 532, a closed caption representation 532, etc. to determine how such media representations 532 should be rendered. For example, the timed metadata representation 532 may indicate a preferred viewpoint, a preferred FOV/viewport over time, etc. Metadata representations 532 may also contain other supporting information such as menu data, encryption/security data, copyright data, compatibility data, etc.

Representations 532 may contain segments 534. A segment 534 contains media data for a predetermined time period (e.g., three seconds). Accordingly, a segment 534 may contain a portion of audio data, a portion of video data, etc. that can be accessed by a predetermined universal resource locator (URL) over a network. The MPD 500 contains data indicating the URL for each segment 534. Accordingly, a client can select the desired adaptation set(s) 530 that should be rendered. The client can then determine the representations 532 that should be obtained based on current network congestion. The client can then request the corresponding segments 534 in order to render the media presentation for the user.

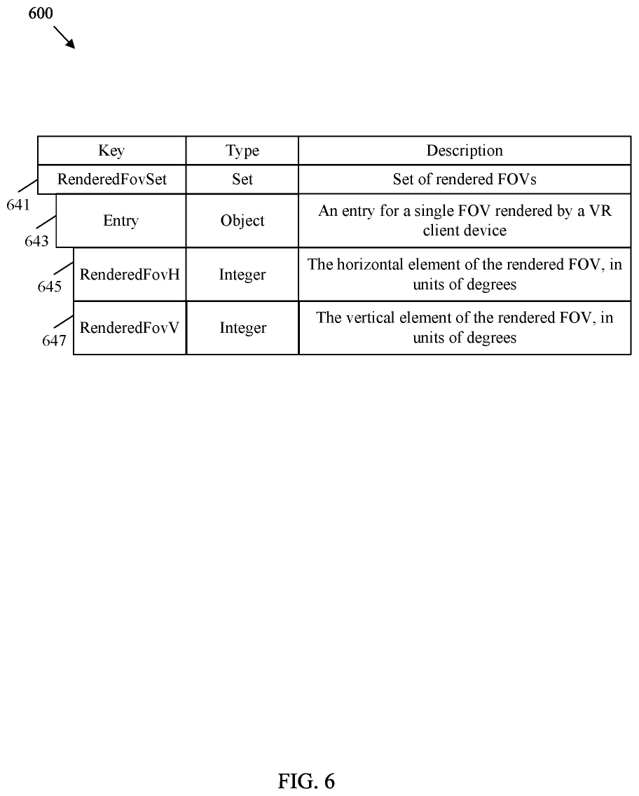

FIG. 6 is a schematic diagram illustrating an example rendered field of view (FOV) set metric 600. The rendered FOV set metric 600 can be employed as part of a media communication session 125 in system 100, and can be employed in response to step 209 and step 211 of method 200. For example, the rendered FOV set metric 600 can carry metrics computed by an MCR module 306 of architecture 300. The rendered FOV set metric 600 can also be employed to implement a rendered FOV set metric of step 431 and/or 432 of media communication session 400.

The rendered FOV set metric 600 includes data objects, which may also be referred to by key words. Such objects may be included as an ordered list or an unordered set. The data objects may include a corresponding type with a description as shown in FIG. 6. Specifically, a rendered FOV set metric 600 can include a RenderedFOVSet 641 object of type set. The RenderedFOVSet 641 object includes a set of rendered FOVs as rendered by one or more rendering devices at one or more clients. Hence, the RenderedFOVSet 641 object can include data describing a plurality of FOVs rendered by a plurality of rendering devices that can be supported by a common client and/or aggregated from multiple clients.

The RenderedFOVSet 641 object of the rendered FOV set metric 600 includes an entry 643 object for each of the FOVs. Specifically, an entry can include a single FOV rendered by a single VR client device at a corresponding rendering device. Hence, a rendered FOV set metric 600 may include one or more (or a plurality of) entries 643 including a plurality of FOVs.

Each entry 643 object may include a horizontal rendered FOV (renderedFOVh) 645 value. The renderedFOVh 645 is an integer that indicates a horizontal element of a corresponding rendered FOV, for example in units of degrees. Each entry 643 object may also include vertical rendered FOV (renderedFOVv) 647 value. The renderedFOVv 647 is an integer that indicates a vertical element of a corresponding rendered FOV, for example in units of degrees.

It should be noted that, while the rendered FOV set metric 600 is described as an unordered set including entry 643 objects, the rendered FOV set metric 600 may also be implemented with the entries 643 as ordered list entries. In such a case, the entries 643 form an ordered list of FOVs described as renderedFOVh 645 and renderedFOVv 647 values. Accordingly, the rendered FOV set metric 600 can be implemented to include an ordered list of rendered FOV metrics for the FOVs in some cases.

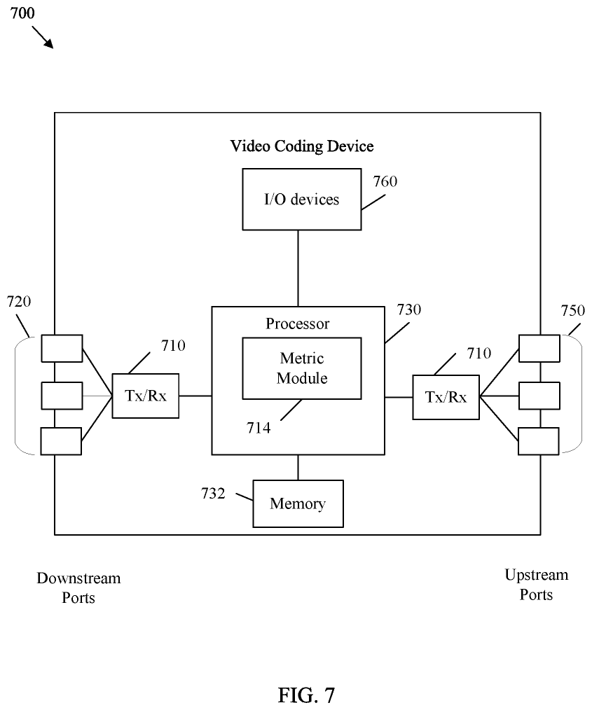

FIG. 7 is a schematic diagram illustrating an example video coding device 700. The video coding device 700 is suitable for implementing the disclosed examples/embodiments as described herein. The video coding device 700 comprises downstream ports 720, upstream ports 750, and/or transceiver units (Tx/Rx) 710, including transmitters and/or receivers for communicating data upstream and/or downstream over a network. The video coding device 700 also includes a processor 730 including a logic unit and/or central processing unit (CPU) to process the data and a memory 732 for storing the data. The video coding device 700 may also comprise optical-to-electrical (OE) components, electrical-to-optical (EO) components, and/or wireless communication components coupled to the upstream ports 750 and/or downstream ports 720 for communication of data via optical or wireless communication networks. The video coding device 700 may also include input and/or output (I/O) devices 760 for communicating data to and from a user. The I/O devices 760 may include output devices such as a display for displaying video data, speakers for outputting audio data, an HMD, etc. The I/O devices 760 may also include input devices, such as a keyboard, mouse, trackball, HMD sensors, etc., and/or corresponding interfaces for interacting with such output devices.

The processor 730 is implemented by hardware and software. The processor 730 may be implemented as one or more CPU chips, cores (e.g., as a multi-core processor), field-programmable gate arrays (FPGAs), application specific integrated circuits (ASICs), and digital signal processors (DSPs). The processor 730 is in communication with the downstream ports 720, Tx/Rx 710, upstream ports 750, and memory 732. The processor 730 comprises a metric module 714. The metric module 714 may implement all or part of the disclosed embodiments described above. For example, the metric module 714 can be employed to implement the functionality of a VR coding device 104, a DASH content server 111, a media aware intermediate NE 113, a client 108, and/or a rendering device 109, depending on the example. Further, the metric module 714 can implement relevant portions of method 200. In addition, the metric module 714 can be employed to implement architecture 300 and hence can implement an MCR module 306. As another example, metric module 714 can implement a media communication session 400 by communicating a rendered FOV set metric 600 in response to receiving an MPD 500 and rendering related VR video sequence(s). Accordingly, the metric module 714 can support rendering multiple FOVs of one or more VR video sequence(s) on one or more clients, take measurements to determine the FOVs rendered, encode the rendered FOVs in a rendered FOV metric, and forward the rendered FOV metric containing multiple FOVs toward a server controlled by a service provider to support storage optimization and enhancement of immersive media quality and related experiences. When implemented on an on a media aware intermediate NE 113, the metric module 714 may also aggregate FOV data from multiple clients for storage in the rendered FOV metric. As such, metric module 714 improves the functionality of the video coding device 700 as well as addresses problems that are specific to the video coding arts. Further, metric module 714 effects a transformation of the video coding device 700 to a different state. Alternatively, the metric module 714 can be implemented as instructions stored in the memory 732 and executed by the processor 730 (e.g., as a computer program product stored on a non-transitory medium).

The memory 732 comprises one or more memory types such as disks, tape drives, solid-state drives, read only memory (ROM), random access memory (RAM), flash memory, ternary content-addressable memory (TCAM), static random-access memory (SRAM), etc. The memory 732 may be used as an over-flow data storage device, to store programs when such programs are selected for execution, and to store instructions and data that are read during program execution.

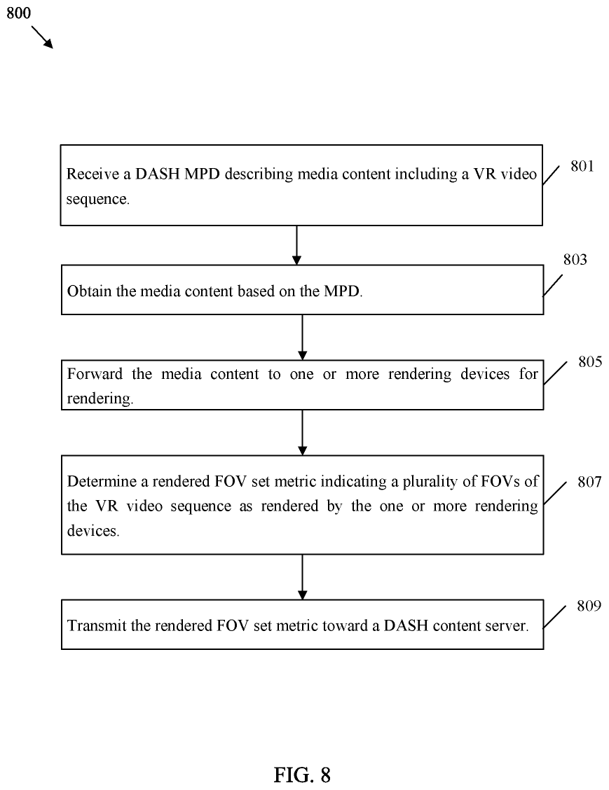

FIG. 8 is a flowchart of an example method 800 of communicating a rendered FOV set metric, such as rendered FOV set metric 600, containing information related to a plurality of FOVs displayed by one or more rendering devices. As such, method 800 can be employed as part of a media communication session 125 in system 100, and/or as part of step 209 and step 211 of method 200. Further, method 800 can be employed to communicate metrics computed by an MCR module 306 of architecture 300. In addition, method 800 can be employed to implement media communication session 400. Also, method 800 may be implemented by a video coding device 700 in response to receiving an MPD 500.

Method 800 may be implemented by a DASH client-side NE, which may include a client, a media aware intermediate NE responsible for communicating with a plurality of clients, or combinations thereof. Method 800 may begin in response to transmitting an MPD request toward a DASH content server. Depending on the device operating the method 800 (e.g., a client or a media aware intermediate NE), such a request can be generated locally or received from one or more clients.

At step 801, a DASH MPD is received in response to the MPD request. The DASH MPD describes media content, and the media content includes a VR video sequence. The media content is then obtained based on the MPD at step 803. Such messages are generated and received by the relevant client(s) and may pass via a media aware intermediate NE, depending on the example. At step 805, the media content is forwarded to one or more rendering devices for rendering. Such rendering may occur simultaneously on the one or more rendering devices.

At step 807, a rendered FOV set metric is determined. The rendered FOV set metric indicates a plurality of FOVs of the VR video sequence as rendered by the one or more rendering devices. When method 800 is implemented on a client, the rendered FOV set metric includes FOVs rendered on multiple rendering devices associated with (e.g., directly coupled to) the client. When method 800 is implemented on a media aware intermediate NE, the contents of FOV data from multiple clients can be employed to determine the contents of the rendered FOV set metric. Once the rendered FOV set metric is determined, the rendered FOV set metric is forwarded toward a provider server at step 809. For example, the rendered FOV set metric can be forwarded toward a DASH content server, an analytics server, or other data repository used by the service provider and/or the content producer that generated the VR video sequence.

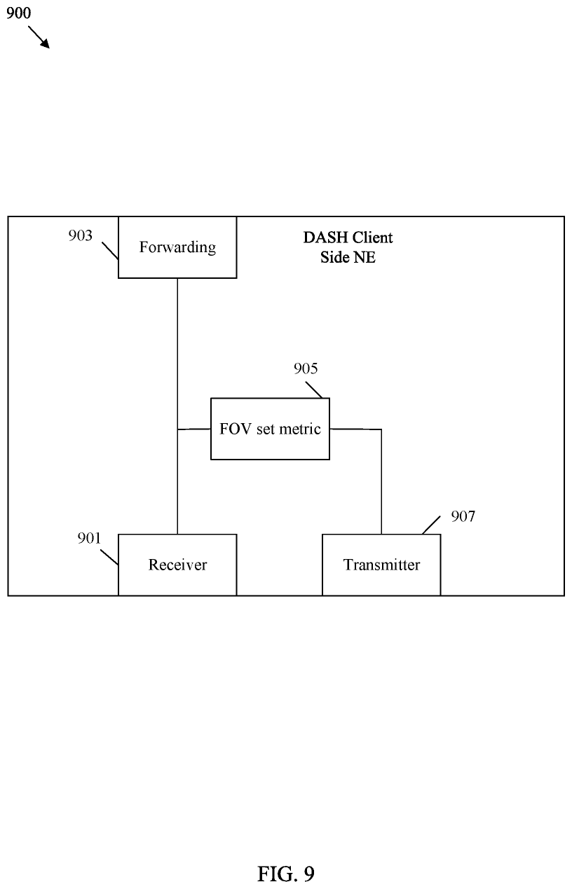

FIG. 9 is a schematic diagram of an example DASH client-side NE 900 for communicating a rendered FOV set metric, such as rendered FOV set metric 600, containing information related to a plurality of FOVs displayed by one or more rendering devices. As such, DASH client-side NE 900 can be employed to implement a media communication session 125 in system 100, and/or to implement part of step 209 and step 211 of method 200. Further, DASH client-side NE 900 can be employed to communicate metrics computed by an MCR module 306 of architecture 300. In addition, DASH client-side NE 900 can be employed to implement a media communication session 400. Also, DASH client-side NE 900 may be implemented by a video coding device 700, and may receive an MPD 500. Further, DASH client-side NE 900 may be employed to implement method 800.

The DASH client-side NE 900 comprises a receiver 901 for receiving a DASH MPD describing media content including a VR video sequence, and obtaining the media content based on the MPD. The DASH client-side NE 900 also comprises a forwarding module 903 (e.g., transmitter, port, etc.) for forwarding the media content to one or more rendering devices for rendering. The DASH client-side NE 900 also comprises a FOV set metric module 905 for determining a rendered FOV set metric indicating a plurality of FOVs of the VR video sequence as rendered by the one or more rendering devices. The DASH client-side NE 900 also comprises a transmitter 907 for transmitting the rendered FOV set metric toward a provider server.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented in a Dynamic Adaptive Streaming over Hypertext Transfer Protocol (HTTP) (DASH) client-side network element (NE), the method comprising:
receiving, by a receiver, a DASH Media Presentation Description (MPD) describing media content including a virtual reality (VR) video sequence;
obtaining, via the receiver, the media content based on the MPD;
forwarding the media content to one or more rendering devices for rendering; and
transmitting, via a transmitter, a rendered field of view (FOV) set metric toward a provider server, the rendered FOV set metric indicating a plurality of FOVs of the VR video sequence as rendered by the one or more rendering devices.

2. The method of claim 1, wherein the plurality of FOVs are rendered simultaneously on two of the rendering devices.

3. The method of claim 1, wherein the rendered FOV set metric includes an entry object for each of the FOVs.

4. The method of claim 1, wherein each entry object includes a horizontal rendered FOV (renderedFOVh) value indicating a horizontal element of a corresponding FOV in units of degrees.

5. The method of claim 1, wherein each entry object includes a vertical rendered FOV (renderedFOVv) value indicating a vertical element of a corresponding FOV in units of degrees.

6. The method of claim 1, wherein the rendered FOV set metric includes a list of rendered FOV metrics for the FOVs.

7. The method of claim 1, wherein the DASH client-side NE is a client, a media aware intermediate NE responsible for communicating with a plurality of clients, or combinations thereof.

8. A Dynamic Adaptive Streaming over Hypertext Transfer Protocol (HTTP) (DASH) client-side network element (NE) comprising:
a receiver configured to:
receive a DASH Media Presentation Description (MPD) describing media content including a virtual reality (VR) video sequence; and
obtain the media content based on the MPD;
one or more ports configured to forward the media content to one or more rendering devices for rendering and to forward a rendered field of view (FOV) set metric toward a provider server; and
a processor coupled to the receiver and the ports, the processor configured to determine the rendered FOV set metric, the rendered FOV set metric indicating a plurality of FOVs of the VR video sequence as rendered by the one or more rendering devices.

9. The DASH client-side NE of claim 8, wherein the plurality of FOVs are rendered simultaneously on two of the rendering devices.

10. The DASH client-side NE of claim 8, wherein the rendered FOV set metric includes an entry object for each of the FOVs.

11. The DASH client-side NE of claim 8, wherein each entry object includes a horizontal rendered FOV (renderedFOVh) value indicating a horizontal element of a corresponding FOV in units of degrees.

12. The DASH client-side NE of claim 8, wherein each entry object includes a vertical rendered FOV (renderedFOVv) value indicating a vertical element of a corresponding FOV in units of degrees.

13. The DASH client-side NE of claim 8, wherein the rendered FOV set metric includes a list of rendered FOV metrics for the FOVs.

14. The DASH client-side NE of claim 8, wherein the DASH client-side NE is a client coupled to the one or more rendering devices via the one or more ports, and further comprising a transmitter configured to communicate with the provider server via at least one of the one or more ports.

15. The DASH client-side NE of claim 8, wherein the DASH client-side NE is a media aware intermediate NE, and further comprising at least one transmitter coupled to the one or more ports configured to forward the media content to one or more rendering devices via one or more clients, the at least one transmitter configured to transmit the rendered FOV set metric toward a provider server.

16. A method comprising:
querying measurable data via one or more observation points (OPs) from functional modules to calculate metrics at a metrics computing and reporting (MCR) module, the metrics including a set of Field of Views (FOVs) rendered by virtual reality (VR) client devices; and
reporting the set of FOVs to an analytics server in a rendered FOV set metric.

17. The method of claim 16, wherein the rendered FOV set metric includes an entry object for each of the FOVs.

18. The method of claim 16, wherein each entry object includes a horizontal rendered FOV (renderedFOVh) value indicating a horizontal element of a corresponding FOV in units of degrees.

19. The method of claim 16, wherein each entry object includes a vertical rendered FOV (renderedFOVv) value indicating a vertical element of a corresponding FOV in units of degrees.

20. The method of claim 16, wherein the render FOV set metric indicates a plurality of FOVs of a VR video sequence.
